(19) United States
(12) Patent Application Publication
(10) Pub. No.: US 2012/0290353 A1
(43) Pub. Date: Nov. 15, 2012

(54) METHOD AND SYSTEM FOR AUTOMATIC CHANNEL OPTIMIZER

(76) Inventors: Naveen K. JAIN, Chicago, IL (US); Amit KHANNA, Gurgaon (IN); Vivek OHRI, Gurgaon (IN); Piyush SHANDILYA, Gurgaon (IN); Jasleen Kaur SINDHU, Gurgaon (IN)

(21) Appl. No.: 13/107,627

(22) Filed: May 13, 2011

(51) Int. Cl. G06Q 10/00

(52) U.S. Cl. 705/7.23; 705/7.12

(57) ABSTRACT

Systems and methods are described for determining an allocation of resources among a plurality of channels. In one embodiment, a business objective is received as user input that corresponds to a participant in a market or business sector. A business segment corresponding to the market participant's products or interests, one or more products within the business segment, and a market channel of the plurality of channels is selected by the user, also as user input. Once these inputs have been established, an high performing allocation resources for achieving the business objective is generated for that market channel.

### TECHNICAL BACKGROUND

The field of business consulting primarily involves assisting businesses and organizations improve performance (e.g., increasing productivity and/or reducing costs), typically through the analysis of existing operational problems and the development of business plans and the deployment or implementation of operating strategies. Various approaches to business consulting have been employed. One popular approach is known as the “expert” or prescriptive approach.

Under an expert approach, the consultant takes the role of expert, and provides expert advice or assistance to the client. Generally, an organization will engage the services of business consultants to gain external (and presumably objective) insight and access to the particular expert's specialized cache of expertise. For example, due to their exposure to and relationships with numerous organizations, consulting firms and their proxies are often keenly aware of an industry's prevailing methodology, and potential pitfalls. This information can be applied to both burgeoning as well as established businesses for growth, to avoid potential challenges, and to make improvements in efficiency.

Other services typically provided by business consultants may include organizational structure and management assistance, development of coaching skills, information technology implementation, strategy development, or operational improvement services (protocols). During a typical consultation period, business consultants generally apply proprietary methodologies to direct the identification and analysis of problems, and to establish a basis for recommendations for more effective or efficient ways of performing business tasks.

Unfortunately, the practice of business consultation is, by nature, at least partially speculative and uncertain. Moreover, since evaluations performed during a consultation period are performed largely manually (though data analysis may be processed automatically) with pre-existing acquired data, any assessments, recommendations, and even projections will naturally have a limited scope as well as a limited applicable duration as new data becomes available, new practices or markets emerge, and as course corrections or other business decisions take effect. Other drawbacks to traditional business or management consulting is the length of time required to generate a comprehensive analysis.

Depending on the particular business or organization and the amount of available data, the process for consulting may require the concerted efforts of up to several teams of consultants working over a period of weeks or even months. Naturally, these services may be quite expensive, and new data acquired during this period may not be included in the analysis. If significant fluctuation is experienced or the volume of sales is unexpected during this period, the analysis may be dated and even rendered (at least partially) obsolete at the moment of delivery. In addition, since the consultation period can itself last a significant period of time, short-term (instant) or follow-up analysis of shorter intervals generally becomes unfeasible or cost-prohibitive.

Other problems specific to the field of product sales is the challenge of selecting the right market channels (“route(s) to market”) to invest in and develop. Markets typically considered include retail, inside sales, direct sales, sales through affiliated partners, and e-commerce. With a (generally) limited budget for sales and marketing, it may become a struggle for companies to determine the appropriate mix of budget allocations (if any) for investing in each of those channels. Traditionally, an empirical approach has been commonly employed, beginning with a somewhat arbitrarily selected mix of allocations—based largely on industry standards—and coupled with subsequent tinkering of the allocation mix to address market trends and perceived and estimated returns as sales data is accrued. Unfortunately, conforming to industry standards and industry trends may be extremely expensive, and ultimately disappointing. Additionally, such a reactive strategy may result in counter-productive measures (e.g., suboptimal market mix allocations) due to short-sighted overreactions, incomplete data, or poor data analysis.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The claimed subject matter is directed to systems and methods determining an high performing allocation of resources to invest between a plurality of market channels by comparing historical performance data to selected benchmark data. The selected benchmark data can be data collected by a third party agency for that particular industry, market or segment. Alternatively, the benchmark data can be comprised from data internal to the business or organization, and specified by the organization/business and a consultant (for example).

In the following embodiments, systems and methods are described for evaluating allocations of resources among a plurality of channels and determining allocations of the same resources with higher performing potential. In one embodiment, a business objective is received as user input that corresponds to a participant in a market or business sector. A business segment corresponding to the market participant's products or interests, one or more products within the business segment, and a market channel of the plurality of channels is selected by the user, also as user input. Once these inputs have been established, an analysis of the allocation of resources for each channel of the plurality of channels is generated. According to one embodiment, the generated analysis may include an evaluation of the investment sensitivity value, a route to market index, a capacity improvement analysis, a route-to-market performance gap analysis, and a determination of a high performance allocation of resources for achieving the business objective for that market channel.

In another embodiment, the analysis generated as output by the system and method include a determination of a high performing allocation of resources among a plurality of market channels according to an applied metric. According to this embodiment, input data including historical performance data, available resources, and a plurality of benchmarks is received from a market participant. The historical Performance data, along with the available resources on customer preferences are then used to generate a plurality of resource allocation mixes. Expected performances are estimated for each of the generated resource allocations, and a pre-determined metric is applied to analyze the generated allocations based on the corresponding estimated performances. The allocation mix with the highest achieving estimated performance according to the metric is selected and may be displayed to the user.

In still further embodiments, the output generated by the system and included in the evaluation may be implemented as graphical representations of: required investment levels to achieve a business objective; analysis of the available routes-to-market based on respective efficiency, productivity, and strategic importance levels; an estimation of the additional investment required to improve capacity; a performance analysis of the routes-to-market of current and prospective allocations according to selected performance benchmarks; and estimated benefits achieved after meeting target performance benchmarks.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 depicts a flowchart of an example process for determining an allocation of resources for a market channel, in accordance with various embodiments of the claimed subject matter.

FIG. 2 depicts a flowchart of an example automated process for selecting an allocation of resources from among a plurality of generated resource allocations for a market channel, in accordance with various embodiments of the claimed subject matter.

FIG. 3 depicts an illustration of an example on-screen user interface in a system for determining an allocation of resources for a market channel, in accordance with various embodiments of the claimed subject matter.

FIG. 4 depicts an illustration of a first example output display of a system for determining an allocation of resources for a market channel, in accordance with various embodiments of the claimed subject matter.

FIG. 5 depicts an illustration of a second example output display of a system for determining an allocation of resources for a market channel, in accordance with various embodiments of the claimed subject matter.

FIG. 6 depicts an illustration of a third example output display of a system for determining an allocation of resources for a market channel, in accordance with various embodiments of the claimed subject matter.

FIG. 7 depicts an illustration of a fourth example output display of a system for determining an allocation of resources for a market channel, in accordance with various embodiments of the claimed subject matter.

FIG. 8 depicts an illustration of a fifth example output display of a system for determining an allocation of resources for a market channel, in accordance with various embodiments of the claimed subject matter.

FIG. 9 depicts a flowchart of an example process for generating an estimated high performing investment allocation for each route-to-market based on user-provided data, in accordance with various embodiments of the claimed subject matter.

FIG. 10 depicts an illustration of an example display of output generated by a system for performing an investment sensitivity analysis, in accordance with various embodiments of the claimed subject matter.

FIG. 11 depicts an illustration of an example display of output generated by a system for performing a route to market segmentation analysis, in accordance with various embodiments of the claimed subject matter.

FIG. 12 depicts an illustration of a example display of output generated by a system for performing a capacity improvement analysis, in accordance with various embodiments of the claimed subject matter.

FIG. 13 depicts an illustration of a first example display of output generated by a system for performing a route to market gap analysis, in accordance with various embodiments of the claimed subject matter.

FIG. 14 depicts an illustration of a second example display of output generated by a system for performing a route to market gap analysis, in accordance with various embodiments of the claimed subject matter.

FIG. 15 depicts an illustration of an example display of output generated by a system performing an analysis of expected benefits from achieving performance benchmarks, in accordance with various embodiments of the claimed subject matter.

FIG. 16 depicts an example computer system, in accordance with various embodiments of the claimed subject matter;

### DETAILED DESCRIPTION

Reference will now be made in detail to the preferred embodiments of the claimed subject matter for automating the generation of high performing budget allocations (“route to market mixes”) for a market participant among a plurality of market channels, examples of which are illustrated in the accompanying drawings. While the claimed subject matter will be described in conjunction with the preferred embodiments, it will be understood that they are not intended to be limit to these embodiments. On the contrary, the claimed subject matter is intended to cover alternatives, modifications and equivalents, which may be included within the spirit and scope as defined by the appended claims.

Furthermore, in the following detailed descriptions of embodiments of the claimed subject matter, numerous specific details are set forth in order to provide a thorough understanding of the claimed subject matter. However, it will be recognized by one of ordinary skill in the art that the claimed subject matter may be practiced without these specific details. In other instances, well known methods, procedures, components, and circuits have not been described in detail as not to unnecessarily obscure aspects of the claimed subject matter.

Some portions of the detailed descriptions which follow are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer generated step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present claimed subject matter, discussions utilizing terms such as “storing,” “creating,” “protecting,” “receiving,” “encrypting,” “decrypting,” “destroying,” or the like, refer to the action and processes of a computer system or integrated circuit, or similar electronic computing device, including an embedded system, that manipulates and transforms data represented as physical (electronic) quantities within the computer system's registers and memories into other data similarly represented as physical quantities within the computer system memories or registers or other such information storage, transmission or display devices.

The claimed subject matter is directed to methods and systems for automating the generation of a market and channel specific evaluation of budget allocations for a for a market participant, and, in particular, generating high performing budget allocations (“route to market mixes”) for the market participant among a plurality of market channels. By automating the generation of an high performing budget allocation, the system is capable of advantageously performing dynamic allocation as new or updated data becomes available. This process also reduces the time required to evaluate the data according to tradition (manual) and prevailing techniques, thereby allowing instant and follow up analysis over shorter intervals.

### Determining Resource Allocation for a Single Market Channel

According to embodiments of the presently claimed subject matter, output generated by an market evaluation system includes determining an high performing allocation of resources to one or more market channels for a market participant. The market channel may comprise, for example, a market channel through which sales of one or more products of the market participant is offered. Thus, an allocation may be determined to increase the volume of sales, achieve greater profits/profitability, acquire a greater market share for the product, or streamline sales operations, for instance. Alternatively, the market channel may also consist of a market channel through which sales of one or more products of the market participant is not currently being offered (e.g., exploring a new market channel or reviving a previously terminated route to market). An allocation may therefore be determined to generate the greatest initial impact, or according to a growth and development plan.

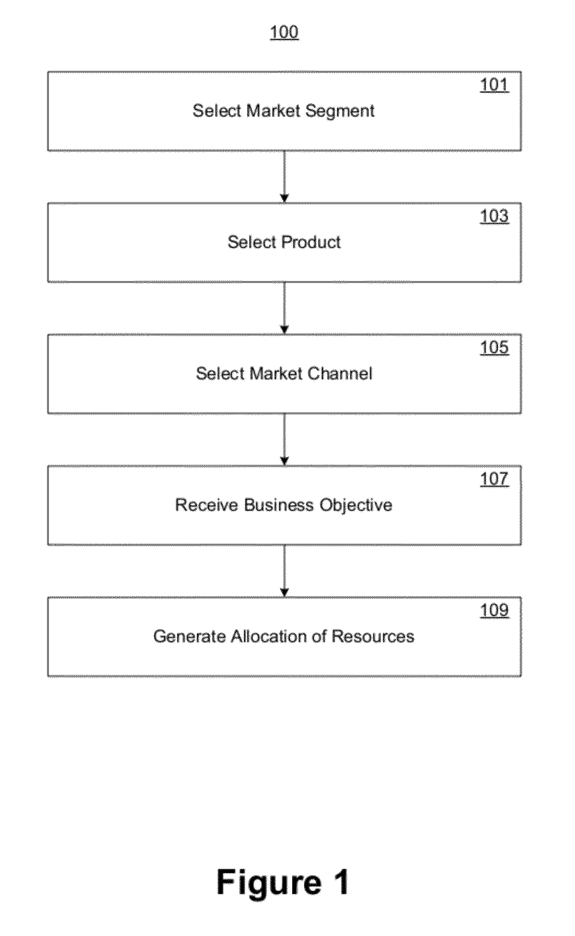

FIG. 1 is a flowchart 100 depicting an example method for determining an allocation of resources for a market channel, in accordance with various embodiments of the claimed subject matter. Although specific steps are disclosed in flowchart 100 (and flowcharts 200 and 900), such steps are example. That is, embodiments of the present invention are well suited to performing various other (additional) steps or variations of the steps recited in flowcharts 100, 200, and 900. It is appreciated that the steps in flowcharts 100 and 200 may be performed in an order different than that which is presented, and that not all of the steps in flowcharts 100, 200, and 900 may be performed. Steps 101-109 describe example steps comprising the method presented in flowchart 100 in accordance with the various embodiments herein described.

Steps 101 through 107 describe example steps which may be performed to receive input from the user. At step 101, a selection of a market segment from a plurality of market segments is received from the user. The selection may be communicated by the user through, for example, a graphical user interface generated by the market channel optimizer system executing on a computing environment and displayed in a display device communicatively coupled to the computing environment The plurality of market segments may comprise, for example, home, small business, large corporation, and international sales. Alternatively, applicable demographic data such as region, departments, etc., may be selected in addition to, or in lieu of, a market segment at step 101.

At step 103, a selection of a specific product or product group from a plurality of products or product groups is received from the user. According to some embodiments, the selection of the product and/or product group may be performed by the user and received from the same user interface through with the selection of the market segment or demographic data was received. Alternatively, a separate, though affiliated user interface may be used to select and receive the product and/or product group. Likewise, at step 105, a selection of a market channel for which an allocation of resources is to be determined is received. As with the market segment and product selections described above with respect to steps 101 and 103, the selection of the market channel may also be accomplished through the same user interface or a related user interface. In alternate embodiments, or where no selection of a market channel is received, the method described in flowchart 100 may be performed for a plurality of market channels.

A business objective (or pre-determined goal) defined by a user for the combination of the market segment, product(s) and market channel(s) is received at step 107. The business objective may be communicated by the user again through, for example, a graphical user interface generated by the market channel optimizer system and displayed in a display device communicatively coupled to the computing environment. A business objective may include (but is not limited to), achieving a volume of sales, greater net profits, a higher relative profitability; acquiring a greater market share; or maintaining a minimum level of sales while reducing costs for the combination of market segment, product(s) and market channel.

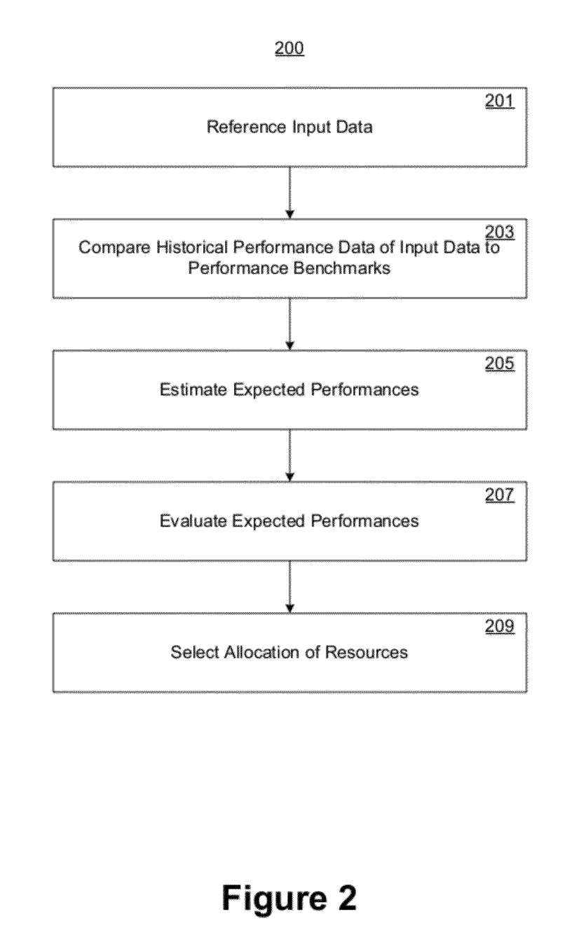

Finally, at step 109, an allocation of resources is generated for the combination of inputs received in steps 101 through 107. An allocation may comprise, for example, a specific sum constituting a portion of a marketing and sales budget, referenced through input data for example. An allocation may also comprise a percentage of a budget. Generating an allocation of resources is described with greater detail in the description of FIG. 2, and may be performed by, for example, referencing pre-acquired input data, comparing the input data to performance benchmarks, estimating performance for a plurality of generated allocations based on the comparison of the input data to the performance benchmarks and selecting the allocation corresponding to the estimated performance which best achieves the business objective received for step 107 for the parameters received in steps 101 through 105.

### Generating Resource Allocations

FIG. 2 is a flowchart 200 depicting an example method for selecting an allocation of resources for a market channel from a plurality of generated resource allocations, in accordance with various embodiments of the claimed subject matter. Steps 201-209 describe example steps comprising the method presented in flowchart 200 in accordance with the various embodiments herein described. In one embodiment, steps 201-209 may be performed as sub-processes of the step 109 described above with respect to FIG. 1.

At step 201, input data for a market participant in one or more market channels is referenced. The input data may be implemented as pre-formatted data in a database implemented by the market channel optimizer system or accessed by the system from a computer readable memory, for example. Alternatively, input data may be received in non-standardized formats and compiled and parsed for relevant data. Input data may include historical performance data, such as transaction (e.g., sales) and financial data attributed to the market participant for a plurality of market channels. The input may also include other financial data such as available resources (e.g., the resources available to invest among one or more market channels), costs (e.g., product cost, channel investments, sales coverage costs, other costs), margins, revenue, and profit sharing agreements, among others. The historical data is referenced to provide a view of relative performance of previously utilized routes to market according to various dimensions, such as lines of business, end-user segments, and comparison between channels.

Input data may also include performance benchmarks. Performance benchmarks may include average or peak conversion rates, average or peak sales sizes, etc for one or more products. These benchmarks may include both internal benchmarks and industry benchmarks. Internal benchmarks comprise actual performance data achieved by the market participant. Industry benchmarks, on the other hand, may comprise average or peak performance data for a leader or average participant in the corresponding industry.

According to further embodiments, the input data may also include historical performance data for a plurality of channel partners. The channel partners may comprise affiliated retail or wholesale vendors of a product or group of products produced by the market participant. In still further embodiments, customer preference data may also be included in input data. Customer preference data may include survey or polling data conducted for the target consuming demographic for a product or group of products produced by the market participant and may provide data indicative of aggregate customer preference or proclivity towards purchasing products through particular market channels. Thus, customer preference data may be expressed as either volumes of sales from a larger aggregate total volume, or a portion (as a percentage) of sales from a whole.

At step 203, the historical performance data referenced in step 201, is compared to one or more selected benchmarks, also referenced in step 201. The selection of one or more performance benchmarks may be pre-determined or, alternatively, a user may be queried through a graphical user interface for a selection among a plurality of performance benchmarks. At step 205, a plurality of resource allocations are generated based on the comparison between the historical performance data and the selected benchmark(s), and expected performances based on the plurality of resource allocations is estimated. The resource allocations may be generated for a single market channel or, in alternate embodiments, for a selection of market channels.

By comparing the historical performance data and the selected benchmarks, variable relationships are derived that enable alignment of expected value to cost and/or effort and allow the identification of discrepancies between the market participant's performance in sales channels. Resource allocations may be generated for one or more market channels, and an expected performance for each resource allocation may be estimated based on the derived relationships. Thus for example, comparison to the benchmarks based on historical performance data may be able to extrapolate the effect of incremental changes to the budget allocations on sales at an aggregate level.

At step 207, the expected performances are evaluated to determine an allocation's progress towards achieving a business objective (such as the business objective received in step 107 of FIG. 1) or other pre-determined goal. Evaluation may be performed by performing a comparison between generated values corresponding to the expected performance, the business objective, and with reference to other input data (as necessary), or according to any other suitable metric. Thus, for example, if a pre-determined goal was to increase the volume of sales to a certain amount, expected performance data would comprise the number of unit sales, for example. Comparison of the number of unit sales corresponding to the expected performance with a historical number of unit sales for a similar period of time may be performed, and the progress may be evaluated against the pre-determined goal. Similarly, the progress towards achieving business objectives such as profits, profit margins, market shares, and other pre-determined goals can be evaluated in a like manner.

Finally, at step 209, the allocation corresponding to the expected performance with the highest achievement relative to the pre-determined goal or business objective is selected. If, under the circumstances, no estimated performance is suitable, the allocation corresponding to the estimated performance which most closely approximates or most substantially performs the business objective is selected instead. On the other hand, if more than one allocation corresponds to an estimated performance which achieves the business objective, all qualifying allocations may be selected or, alternatively, the allocation with the single highest performance may be selected. Once the allocation(s) is selected, the allocation(s) may be displayed to the user through a user interface presented in a display device. In still further embodiments, a ranked list of market partners based on the historical performance of the respective market partners may also be generated at step 209 or an adjacent step. Thus, an allocation according to both specific market channels and market partners may be generated.

### Example User Interfaces

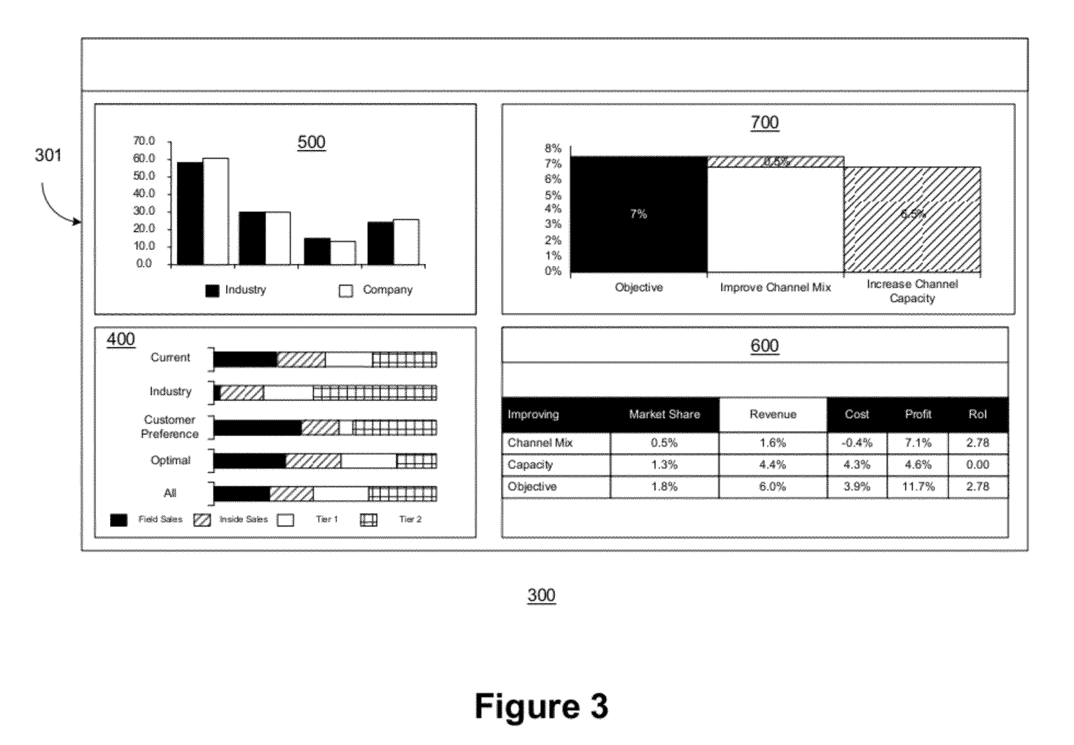

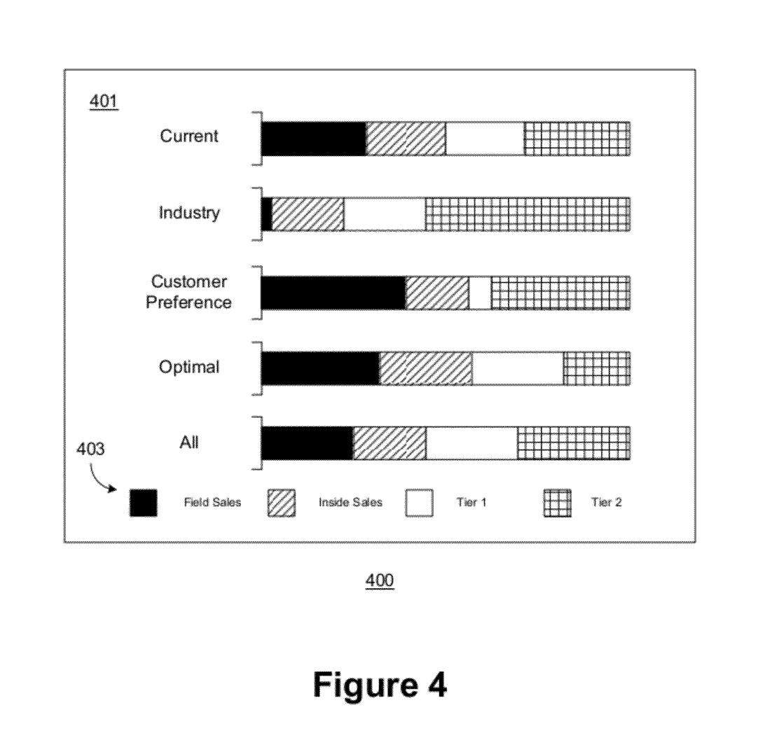

FIG. 3 displays an illustration of a first example output display 300 of a system for determining an allocation of resources for a market channel, in accordance with various embodiments of the claimed subject matter. As depicted, display 300 aggregates the displays 400, 500, 600 and 800 described below with respect to FIGS. 4-8 in a single display 301. Each display 400, 500, 600, 700 and 800 may be presented in the graphical user interface 300 and displayed to the user through a display device.

FIG. 4 depicts an illustration of a first example output display 400 of a system for determining an allocation of resources for a market channel, in accordance with various embodiments of the claimed subject matter. The output display 500 may be generated by a market channel optimizer system and displayed through a user interface, such as user interface 300 described above with respect to FIG. 3. As depicted, Display 400 presents data pertaining to relative budget allocation levels, including current allocation/performance data, historical performance data, industry data, high performing allocation data, and a combination of one or more fields. This data may correspond to one or more market segments, one or more products, services, or fields, and for a particular market participant (e.g., the market participant affiliated with the user of the system. As shown, Display 400 depicts a graphical representation of a plurality of relative budget allocations for a plurality of market channels.

As depicted in display 400, relative budget allocations 401 are depicted for four market channels 403: “field sales,” “inside sales,” “tier 1 sales,” and “tier 2 sales.” The relative allocations 401 pertain to a current allocation mix, an industry standard allocation mix, a customer preference allocation mix, the high performing generated allocation mix, and a combination (or average) of all of the other allocation mixes displayed. Thus, for example, the current allocation mix represents the relative budget allocations (“route to market mix”) among the market channels for current or from the most recent budget period. Industry allocation represents the route to market mix for an average, or peak industry standard.

Customer preference may represent the relative proportions of total sales for one or more market participants for a relevant product, service or field and/or for a specified market segment. This data may be acquired through customer surveys conducted by either external agencies or internally. High performing allocation represents the route to market mix with the highest estimated performance based on the business objective and weighted for the customer preference for each channel. The All allocation represents an average of the other allocations presented. Alternatively, the All allocation may represent the high performing rout to market mix for all products or services of a market participant based on the business objective and weighted for customer preference for each channel.

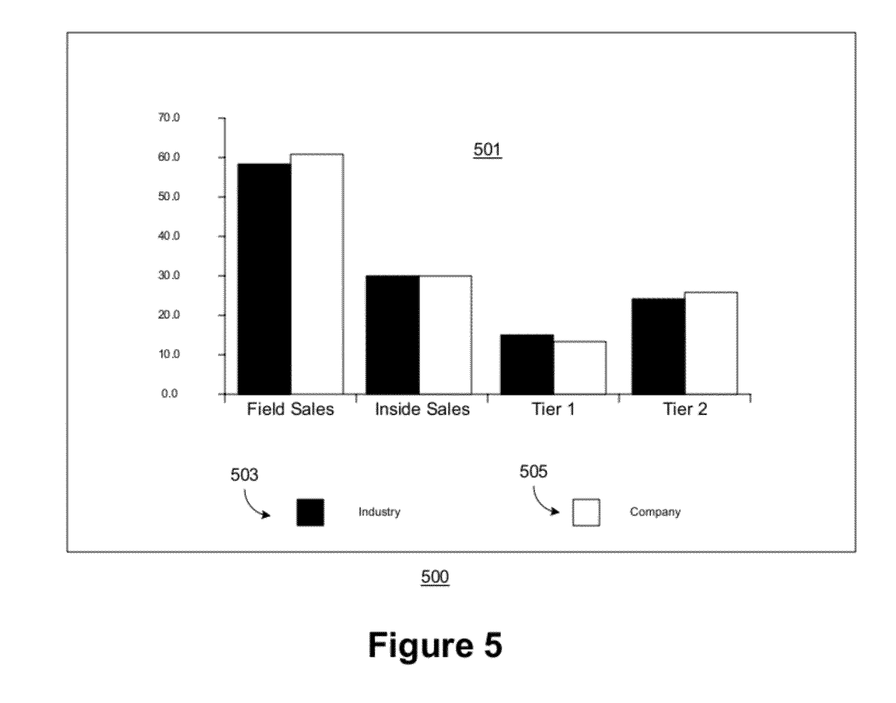

FIG. 5 depicts an illustration of a second example output display 500 of a system for determining an allocation of resources for a market channel, in accordance with various embodiments of the claimed subject matter. As presented, display 500 presents data pertaining to a comparison between actual (current) performance relative to one or more performance benchmarks. This data may correspond to one or more market segments, one or more products, services, or fields, and for a particular market participant (e.g., the market participant affiliated with the user of the system. As shown, Display 500 depicts a plurality of bar graphs 501 representing the relative performance of a current budget allocation 503 to a performance bench mark 505.

Within display 500, the performance comparisons are displayed for four market channels, correlating to the market channels depicted in display 400: “field sales,” “inside sales,” “tier 1 sales,” and “tier 2 sales.” Each comparison presents the performance of a current budget allocation 503 (as indicated by the corresponding color or pattern scheme) and a pre-designated performance bench mark 505 (likewise indicated by a corresponding color or pattern scheme). Performance may be based on productivity, as measured by one or more metrics, such as average deal size, conversion rate, cost per unit, where productivity can be calculated as the average deal size multiplied by the conversion rate and divided by the cost per unit. Additional performance benchmarks may include, but are not limited to, average or median performance of a route to market based on historical data, or external industry performance benchmarks.

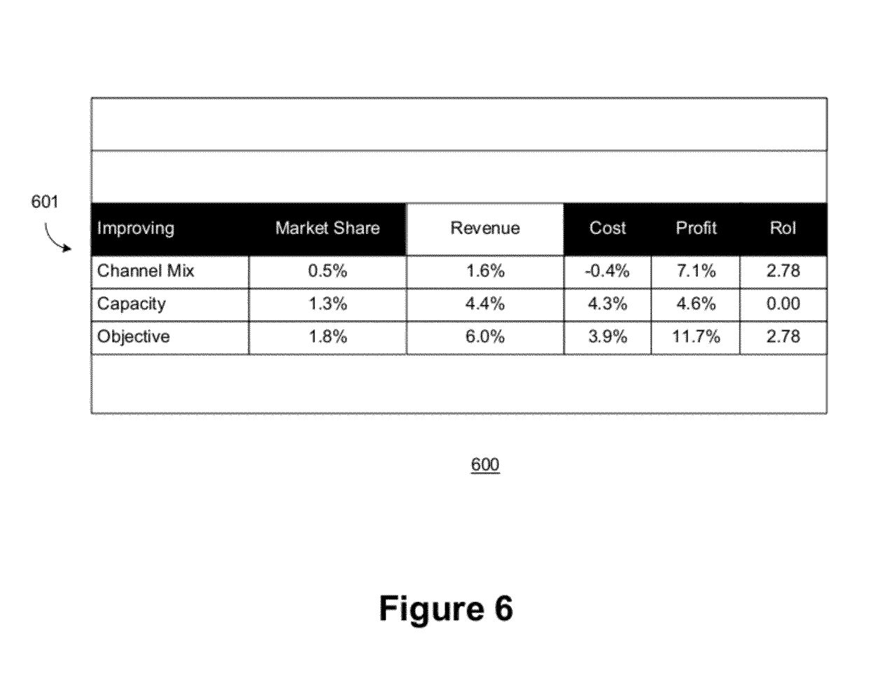

FIG. 6 depicts an illustration of a third example output display 600 of a system for determining an allocation of resources for a market channel, in accordance with various embodiments of the claimed subject matter. As depicted, display 600 presents data pertaining to the expected change attributed to distributing a marketing or sales budget according to one or more allocation mixes. This data may correspond to one or more market segments, one or more products, services, or fields, and for a particular market participant (e.g., the market participant affiliated with the user of the system. As shown, Display 600 depicts a display window 601 which presents the expected changes achieved through a plurality of allocations over the current route to market mix.

As depicted in FIG. 6, display window 601 displays the change expected through achievement of a business objective (“Objective”), the change expected through re-alignment of the current channel allocations weighted for one or more metrics (e.g., profitability and/or customer preference), and the change expected through improvement of route to market capacity (such as through additional channel incentives and/or channel partners). As presented in display window 601, the changes are presented in terms of market share, revenue, cost, profit and Return on Investment, though embodiments are well suited to presentations in other terms.

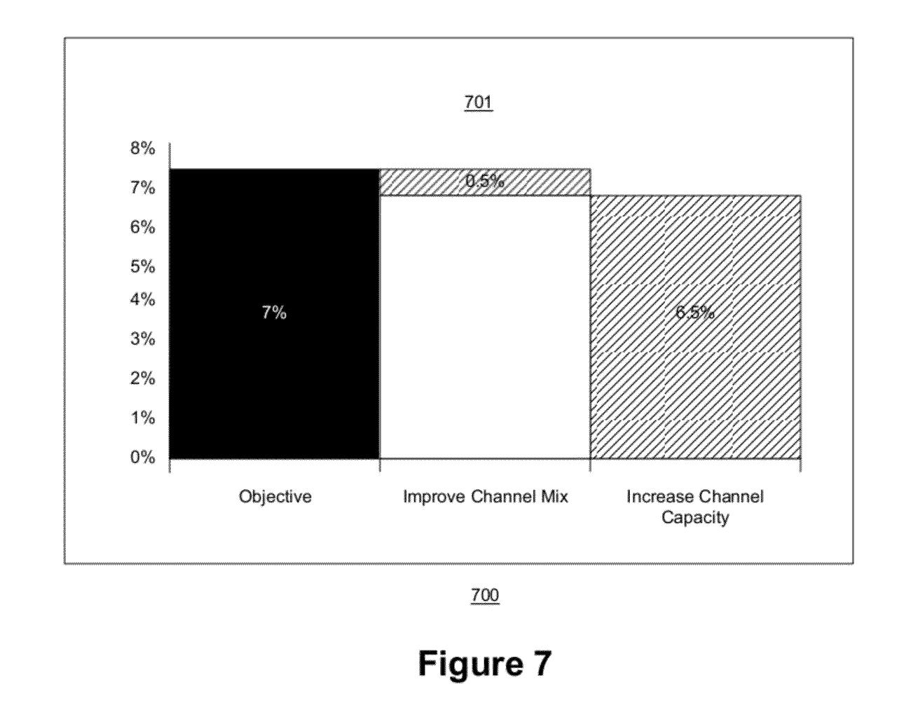

FIG. 7 displays an illustration of a fourth example output display 700 of a system for determining an allocation of resources for a market channel, in accordance with various embodiments of the claimed subject matter. As depicted, display 700 presents data pertaining to the expected gain attributed to distributing a marketing or sales budget according to an high performing allocation mix. This data may correspond to one or more market segments, one or more products, services, or fields, and for a particular market participant (e.g., the market participant affiliated with the user of the system. As shown, Display 700 depicts a display window 701 which presents the expected gain achieved through a generated high performing allocation mix.

As depicted in FIG. 7, display window 701 displays the gain expected through allocating resources according to an high performing allocation mix. As presented in display window 701, Objective represents the percentage gain (e.g., in revenue growth rate, for example) over current performance attributable to the high performing allocation mix. As comparison points, the gain achieved through re-alignment of the current channel allocations weighted for one or more metrics (e.g., profitability and/or customer preference) only is represented under “Improve Channel Mix,” as well as the gain expected through improvement of route to market capacity (such as through additional channel incentives and/or channel partners) only (represented under “increase Channel Capacity.”

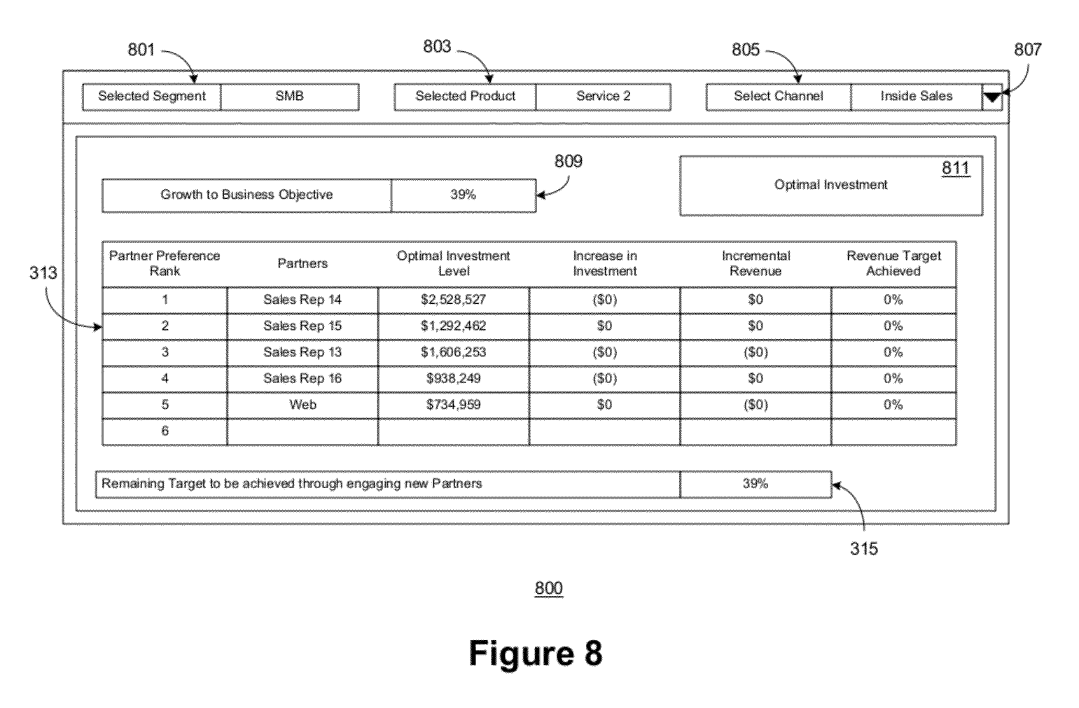

With respect to FIG. 8, an illustration of a fifth example on-screen user interface 800 of a market channel optimizer system is depicted, in accordance with embodiments of the present invention. According to one embodiment, user-interface 800 includes a plurality of sub-interfaces (e.g., selection sub-interfaces 801, 803, 805 and 809) and a plurality of graphical display windows for arranging and presenting data (e.g., display windows 813, and 815). Interface 800 may also include one or more buttons (e.g., 811) which, when actuated by the user through the user interface, performs one or more indicated functions.

As depicted, the plurality of sub-interfaces 801, 803, and 805 in interface 800 allow a user to select parameters under which a generated allocation of resources between market channels is performed. As shown in FIG. 8, these parameters may correspond to the user input received from a user in steps 101 through 105 described above with respect to flowchart 100. Thus, for example, sub-interface 801 allows a user to select a market segment (such as small business, abbreviated as “SMB”). Sub-interface 803 allows a user to select a product or group of products (identified as “Service 2”). Sub-interface 805 allows the user to select a particular market or sales channel (e.g., “inside Sales”). In some embodiments, the input may be directly entered (typed) into a corresponding input window. Alternatively, a selection from a plurality of selections may be listed, from which the user is able to select one (or more) options. The plurality of selections may be implemented as a drop down box, for example, such as the drop down box 807 corresponding to sub-interface 805.

Once the parameters have been entered by a user, a business objective may be selected in sub-interface 809. According to other embodiments, the progress remaining to reach a pre-specified business objective may be represented sub-interface 809 in addition to, or in lieu of a business objective sub-interface. Thus as displayed in user interface 800, if a pre-designated business objective was a target growth percentage, the progress remaining to achieve the business objective (as depicted, an example value of 39%) may be displayed in sub-interface 809. Further data may be displayed in one or more graphical display windows (display windows 813, 815). As shown, display window 813 depicts a ranked order of market partners, with high performing investment levels, increase in investment, incremental revenue and % of revenue target achieved relative to the current investment levels.

As depicted, display window 813 may display as default data corresponding to the current investment level until an optional investment allocation is performed. An optional investment allocation may be performed according to the method described above with respect to FIG. 2, and may be initiated by a user through actuation of a button, such as button 811. In one embodiment, once button 811 is actuated, the data presented in display window 313 may be replaced with data from a generated high performing allocation. Actuating button 811 again may, in some embodiments, revert the data presented to reflect current investment levels, with the corresponding text modified accordingly. User interface 800 may also include display window 815, which presents the remaining progress to be achieved to reach the business objective.

### Additional Output

According to some embodiments, output generated by the system for evaluating market participant budget allocation data may also include at least one evaluation from a list of evaluations that includes an evaluation of the investment sensitivity value, a route to market index, a capacity improvement analysis, a route-to-market performance gap analysis, and the estimated gains achieved by meeting specified benchmarks, each output being implemented as a separate tool or software module. According to some embodiments, data (e.g., user supplied input data) may be shared between and among the tools.

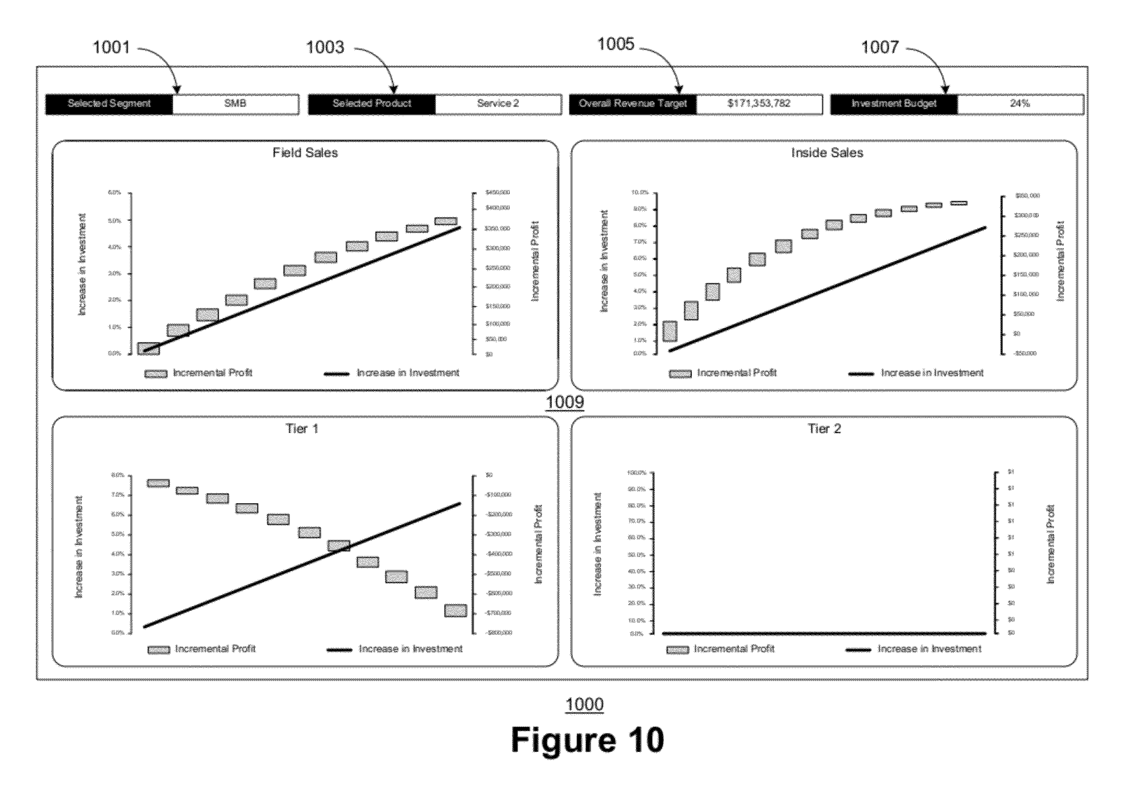

These outputs may be implemented as one or more graphical representations displayed in a user interface of the system. For example, the investment sensitivity analysis may be implemented as a graphical display (e.g., a graph) that plots required investment levels to achieve a business objective over the expected gains corresponding to the investment level. The route to market index may be implemented as a graphical display of the available routes-to-market, arranged according to each route's respective efficiency, productivity, and strategic importance levels, and may include a recommendation of the highest performing route-to-market allocation. The capacity improvement analysis may be implemented as a graphical representation of the additional investment required to improve capacity. The route-to-market performance gap analysis may be implemented as a graphical representation of the routes-to-market of current and prospective allocations according to selected performance benchmarks. Finally, estimated gains achieved by meeting specified benchmarks may simply represent, graphically, any and all estimated benefits achieved after meeting target performance benchmarks. Sample graphical output are provided in FIGS. 10-15 and described in greater detail below.

### Investment Sensitivity Analysis

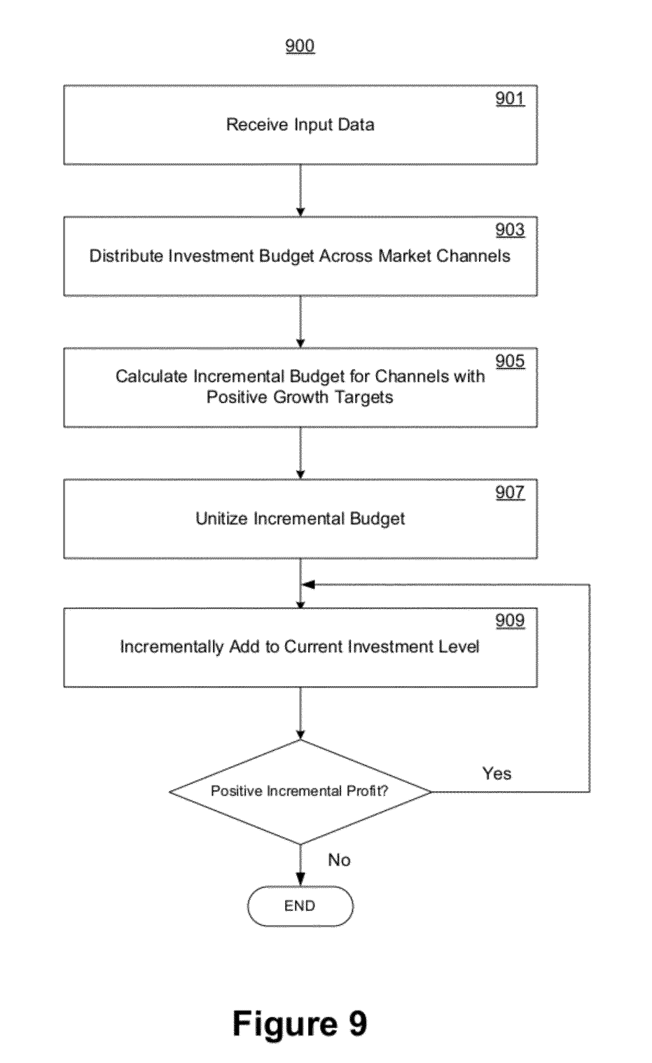

According to one embodiment, the investment sensitivity analysis may generate an estimated high performing investment for each route-to-market based on a provided revenue target and investment budget. FIG. 9 is a flowchart 900 depicting an example method for generating an estimated high performing investment allocation for each route-to-market based on user-provided data. Steps 901-9097 describe example steps comprising the method presented in flowchart 900. At step 901, input data is received from the user. Input data may include, for example, a selected segment, product, revenue target, and investment budget. Revenue target may be expressed as either a target market share, or a overall revenue target (e.g., calculated from the size of the market and the target market share). The investment budget may be expressed as a percentage of the projected target revenue. An allocation of the investment budget may be thereafter calculated at step 903 by computing an overall revenue target based on a business objective, computing a route-to-market revenue target based on the allocation, and estimating growth targets for each channel based on the route-to-market revenue target.

For the channels with positive growth targets, an incremental budget is calculated at step 905 as the difference between the proposed investment budget and current investment, and converted into a percentage. Subsequently, the incremental budget for each channel with a positive growth target is unitized (e.g., by dividing the budget into discrete units) at step 907, and the effect of an additional investment of an incremental unit over the current investment level is calculated at 909. The calculation may be repeated until an investment level is reached at which incremental profit becomes zero, or when the total profit reaches a maximum.

According to some embodiments, this data may be expressed as one or more graphs (e.g., line graphs). FIG. 10 depicts an illustration of an example display 1000 of a graphical output generated during an investment sensitivity analysis performed in a system for evaluating market participant budget allocation data, in accordance with embodiments of the claimed subject matter. As depicted, display 1000 graphically presents the incremental profit and increase in investment for one or more market channels based on input data. This data may, for example, correspond to one or more market channels within one or more market segments, one or more products, services, or fields, and for a particular market participant (e.g., the market participant affiliated with the user of the system. This data may also include an overall revenue target and an allotted investment budget. This input data may be entered by a user (e.g., through data entry fields 1001, 1003, 1005, 1007) or may be referenced from pre-entered input (e.g., through other tools of the system for evaluating market participant budget allocation). As presented, the graphical display 1100 also includes a graphical display 1109, which includes one or more line graphs which plot the relative incremental profit and increase in investment for one or more market channels.

### Route to Market Segmentation

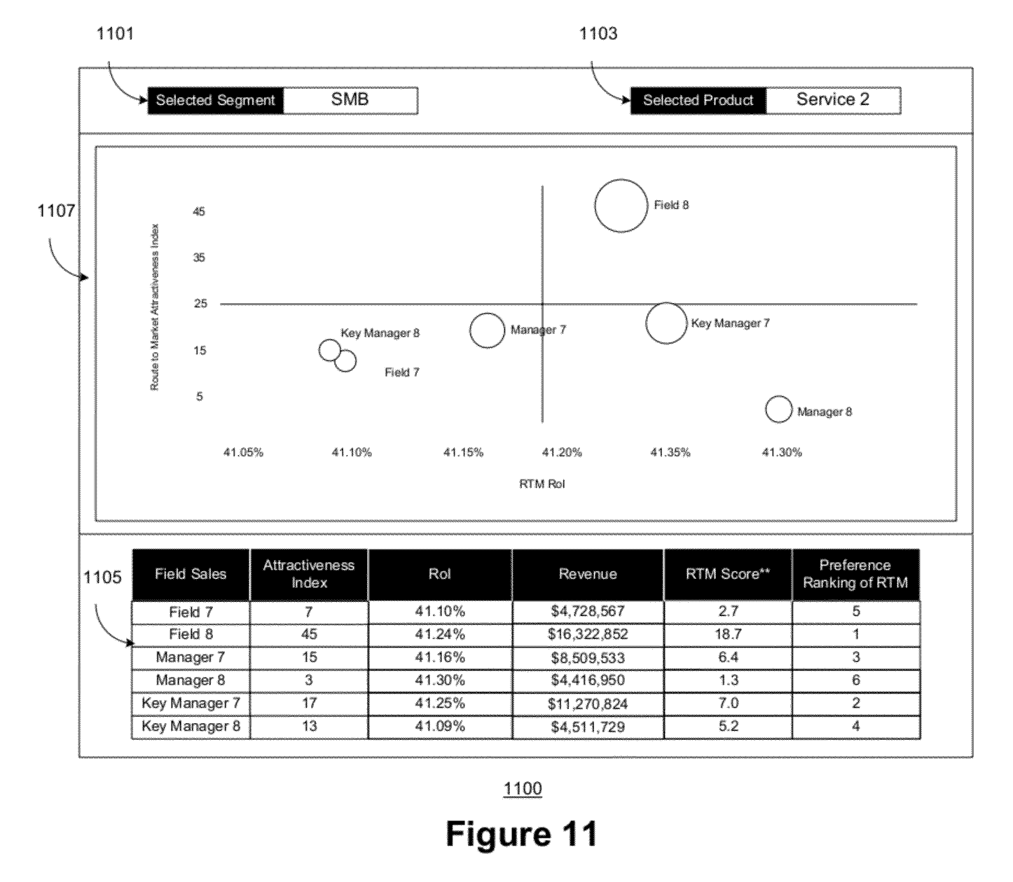

According to one embodiment, the route-to-market index may be implemented as a graphical display which segments market partners based on respective gauged strategic importance and profitability. According to further embodiments, the graphical display may be presented as a composite index which ranks the market partners for a market participant. FIG. 11 depicts an illustration of an example display 1100 of output generated by a system for performing a route to market segmentation analysis, in accordance with various embodiments of the claimed subject matter. As depicted, display 1100 presents an attractiveness index for one or more routes-to-market based on a variety of input data. This data may, for example, correspond to one or more market segments, one or more products, services, or fields, and for a particular market participant (e.g., the market participant affiliated with the user of the system. This data may also include sale volumes, growth rates, conversion rates, and average deal sizes or volumes attributable to field sales/indirect sales or through indirect channels. As presented, the graphical display 1101 also includes an RTM score, which represents the desirability or “attractiveness” of a particular route-to-market, factoring in a return of investment. Each route to market may be ranked according to the route's respective attractiveness.

In further embodiments, the graphical output 1100 may include a visual relative representation of the market segments, such as a graphical plot (e.g., graph 1107). As depicted, the graph 1107 plots the relative attractiveness indices (Y-axis) and the RTM Return on Investments (X-axis) of the individual market segments. Preferred (e.g., high-scoring) market segments may, for example, be plotted in the first (upper right) quadrant. Poorer performing market segments may be relegated to the third (bottom left) quadrant. By generating a display having a graphical relativity between market segments, users are provided a way to visually distinguish the relative attractiveness of particular market segments, which may improve understanding of the relative market segments and the respective expected performances, and lead to simplifying complex decision making in allocating resources amongst the market segments.

### Capacity Improvement

A capacity analysis may be performed by the automatic channel optimizer system and implemented as a graphical display which measures the required change in capacity of each of a plurality of routes to market to achieve a stated business objective. Capacity increased may include channel incentives, headcount, and increasing the number of partners, for example. After receiving input from a user (such as a selected segment, selected product or service, and a selected channel), the system automatically calculates the required growth to meet the business objective. The selected channels may, for example, include Field Sales (Direct Sales), Inside Sales and Indirect Sales (which may be further segmented into tiers). Calculating the required growth may be performed by using a proposed high performing allocation (e.g., as calculated in FIG. 1) with a revenue growth target (e.g., as calculated in FIG. 9). Once the required growth is calculated, the revenue growth achieved by each current partner in a channel is added to get an estimate of total revenue growth that can be achieved through increasing channel investments. The value attributable to current partners is subtracted from the growth target to obtain the value which may be best attainable through the addition of new partners.

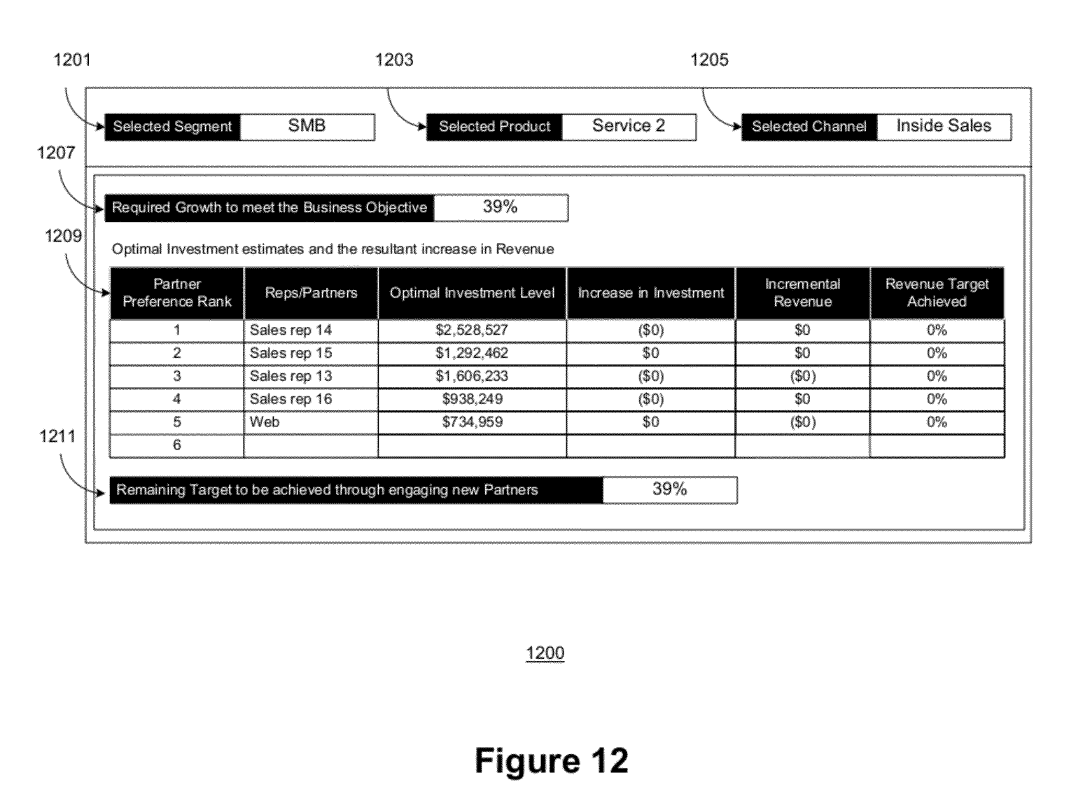

FIG. 12 depicts an illustration of a first example display 1200 of output generated by a system for performing a capacity improvement analysis, in accordance with various embodiments of the claimed subject matter. As depicted, display 1200 provides input fields 1201, 1203, and 1205, which allow the user to select the particular segment (e.g., small or large business), product or service, and channel (e.g., field, indirect, or inside sales). Once input, this data is used to calculate the required growth to meet a pre-defined business objective (displayed in field 1207, for example). According to further embodiments, estimated available revenue growth of current partners may also be displayed (e.g., in window 1209). Finally, any remaining growth attributable to the increasing capacity (e.g., by engaging new partners) is provided in field 1211.

### Route to Market Gap Analysis

According to still further embodiments, a Route-To-Market Gap analysis may be performed by the automatic channel optimizer system and implemented as a graphical display which measures the gap in current performance of a route-to-market in comparison to the estimated performance based on performance benchmarks. After receiving input from a user (such as a selected segment, selected product or service, and a selected channel), the system automatically calculates the gap in route-to-market performance between current and potential allocations. The data for performance benchmarks may be sourced from, for example, historical average or median performance of the route-to-market, or an external agency's research data.

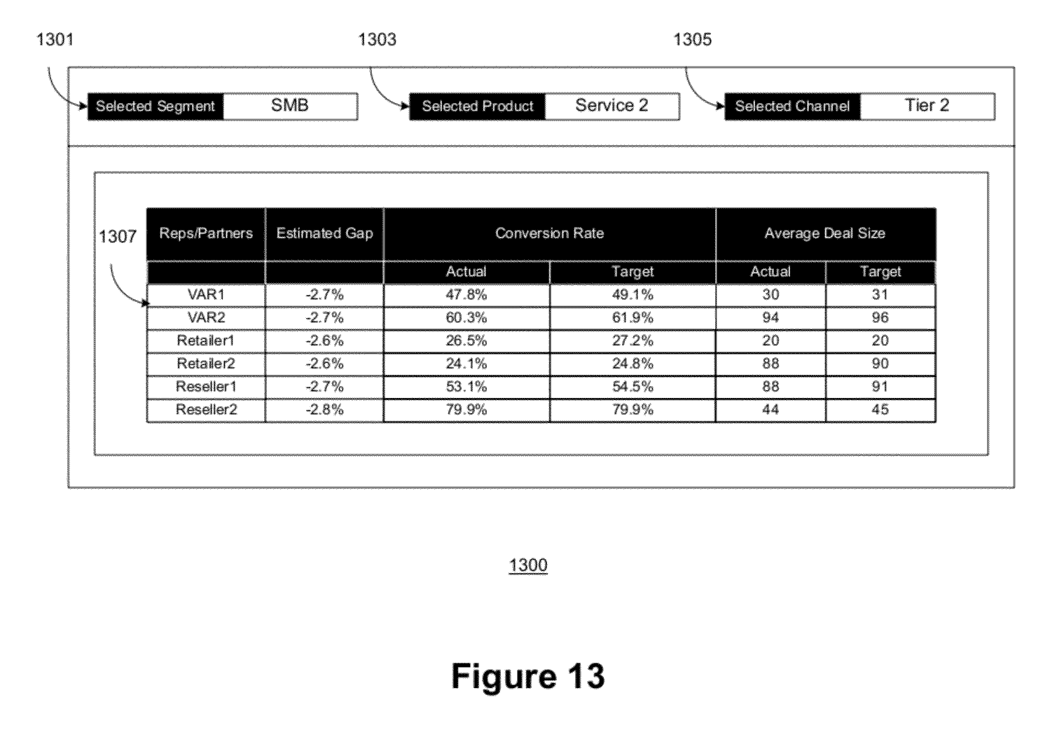

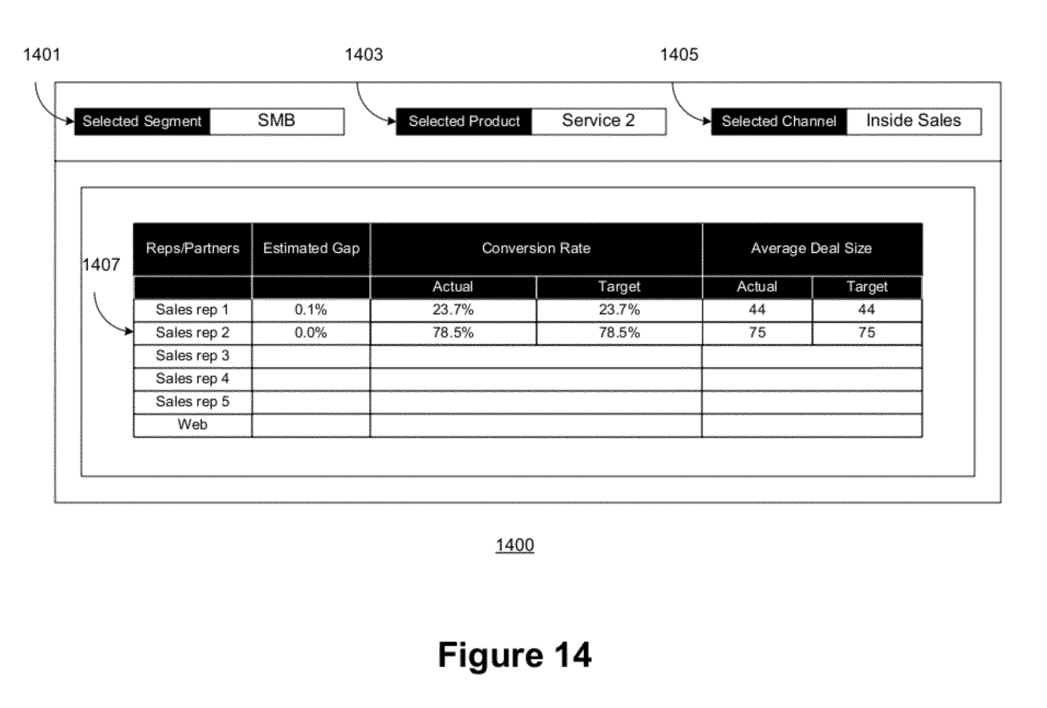

FIGS. 13 and 14 depict an illustration of a first and second example display (e.g., 1300, 1400) of output generated by a system for performing Route-to-Market Gap analysis, in accordance with various embodiments of the claimed subject matter. As depicted, displays 1300 and 1400 each provide input fields (1301-1305, 1401-1405), which allow the user to select the particular segment (e.g., small or large business), product or service, and channel (e.g., field, indirect, or inside sales). Once input, this data is used to calculate the disparity between current performance and estimated benchmark performance for a particular route-to-market (e.g., Window 1307, 1407). As presented, Windows 1307 and 1407 include data to identify the particular representative or partners within a channel, the estimated gap between current performance and an industry benchmark, and the estimated conversion rate (or average deal size) at which the selected route-to-market should operate to bridge the gap in performance.

### Benchmark Performance Analysis

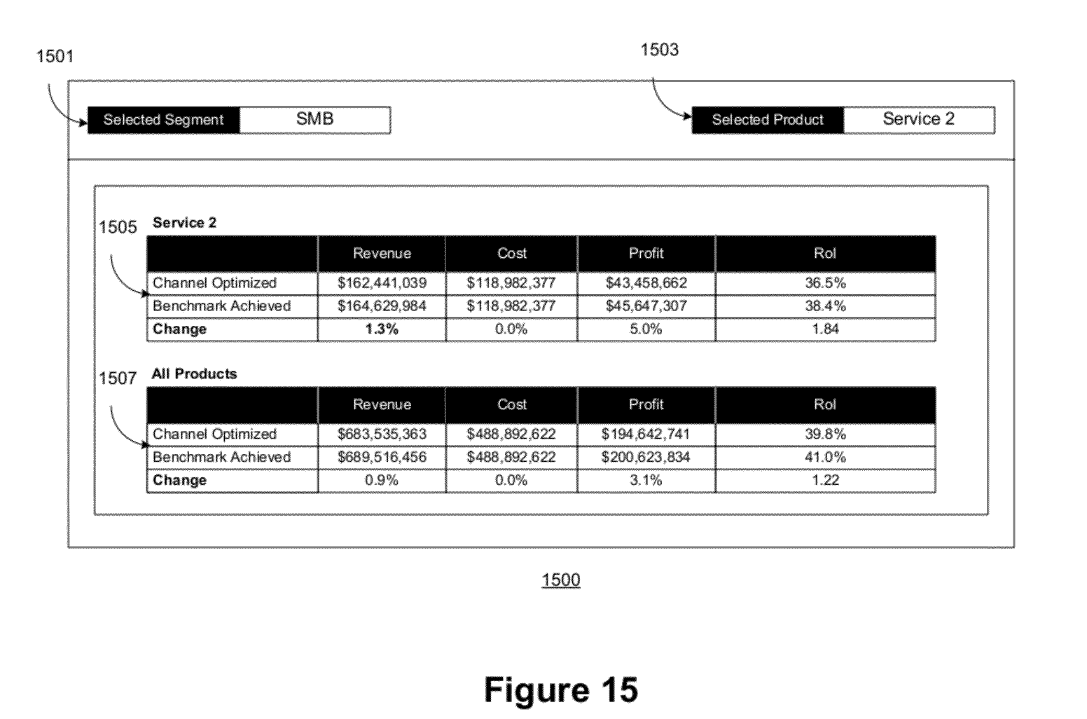

According to yet further embodiments, an analysis of expected benefits from achieving performance benchmarks may also be included as output generated by the automatic channel optimizer system and implemented as a graphical display which measures the change in expected performance after reaching pre-determined performance benchmarks. After receiving input from a user (such as a selected segment, and a selected product or service), the system automatically compares the current productivity and performance of current route-to-market allocations with the industry performance benchmarks. The benefits of operating at the performance benchmark levels are subsequently computed by imposing the performance benchmark allocations on the route-to-market and computing the resulting potential sales, return on investment, revenue, cost, and profit based on the imposed performance benchmark allocations. FIG. 15 depicts an illustration of an example display (e.g., 1500) of output generated by a system for calculating benefits from achieving benchmarks, in accordance with various embodiments of the claimed subject matter. As depicted, display 1500 provide input fields (1501, 1503), which allow the user to select the particular segment (e.g., small or large business), and product or service. Once input, this data is used to calculate the estimated change in sales after reaching the pre-defined industry benchmark.

### Example Computer System

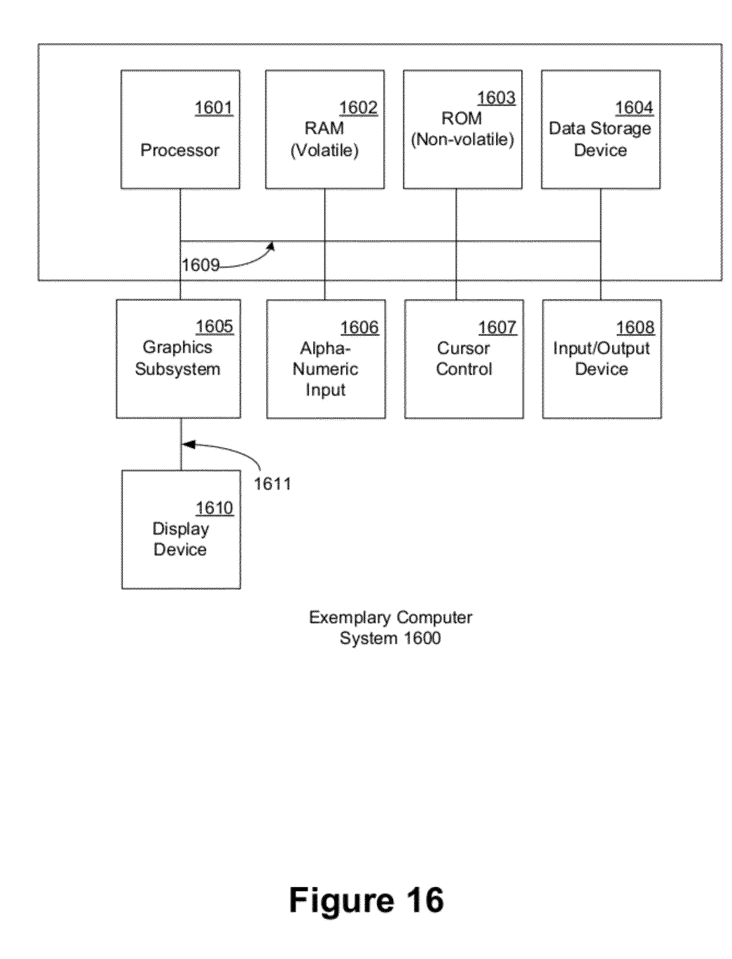

As presented in FIG. 16, an example system 1600 upon which embodiments of the present invention may be implemented includes a general purpose computing system environment. In its most basic configuration, computing system 1600 typically includes at least one processing unit 1601 and memory, and an address/data bus 1609 (or other interface) for communicating information. Depending on the exact configuration and type of computing system environment, memory may be volatile (such as RAM 1602), non-volatile (such as ROM 1603, flash memory, etc.) or some combination of the two.

Computer system 1600 may also comprise an optional graphics subsystem 1605 for presenting information to the computer user, e.g., by displaying information on an attached display device 1610, connected by a video cable 1611. According to embodiments of the present claimed invention, the graphics subsystem 1605 may be coupled directly to the display device 1610 through the video cable 1611. A graphical user interface or graphical output of an application for determining resource allocation for a plurality of market channels described above with respect to FIGS. 3-8, and executing in the computer system 1600, may be generated in the graphics subsystem 1605, for example, and displayed to the user in the display device 1610. In alternate embodiments, display device 1610 may be integrated into the computing system (e.g., a laptop or netbook display panel) and will not require a video cable 1611. In one embodiment, generation of on-screen graphical displays by the channel automatic channel optimizer system may be performed by graphics subsystem 1605 in conjunction with the processor 1601 and memory 1602, with any resulting output displayed in attached display device 1610.

Additionally, computing system 1600 may also have additional features/functionality. For example, computing system 1600 may also include additional storage (removable and/or non-removable) including, but not limited to, magnetic or optical disks or tape. Such additional storage is illustrated in FIG. 9 by data storage device 1607. Computer storage media includes volatile and nonvolatile, removable and non-removable media implemented in any method or technology for storage of information such as computer readable instructions, data structures, program modules or other data. RAM 1602, ROM 1603, and data storage device 1607 are all examples of computer storage media.

Computer system 1600 also comprises an optional alphanumeric input device 1606, an optional cursor control or directing device 1607, and one or more signal communication interfaces (input/output devices, e.g., a network interface card) 1609. Optional alphanumeric input device 1606 can communicate information and command selections to central processor 1601. Optional cursor control or directing device 1607 is coupled to bus 1609 for communicating user input information and command selections to central processor 1601. Signal communication interface (input/output device) 1609, also coupled to bus 1609, can be a serial port. Communication interface 1609 may also include wireless communication mechanisms. Using communication interface 1609, computer system 1600 can be communicatively coupled to other computer systems over a communication network such as the Internet or an intranet (e.g., a local area network), or can receive data (e.g., a digital television signal).

Accordingly, by automating the generation of high performing budget allocations (“route to market mixes”) for a market participant among a plurality of market channels by performing the methods described above, a corresponding system is capable of advantageously performing dynamic allocation as new or updated data becomes available, while simultaneously reducing the length of time required to evaluate the data according to tradition methodologies, thereby allowing flexible, efficient, and responsive analysis.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. In particular, while embodiments of the claimed subject matter have been described with reference to a cloud infrastructure for the sake of clarity, it is to be understood that the subject matter is not limited to implementations which include such an infrastructure. Instead, the claimed subject matter is well suited to alternate configurations of distributed networking systems, which may include, but are not limited to cloud infrastructures and private enterprise network infrastructures.

What is claimed is:

1. A method for determining an allocation of resources for a market channel, the method comprising:
receiving a selection of a market segment from a plurality of market segments;
receiving a selection of a product from a plurality of products corresponding to the market segment;
receiving a selection of a market channel from a plurality of market channels corresponding to the market segment;
receiving a business objective corresponding to a market participant; and
automatically generating an allocation of resources to achieve the business objective for the market participant corresponding to a combination of the market segment, the product and the market channel, wherein the automatically generating an allocation of resources is performed in a computing system.

2. The method according to claim 1, wherein the automatically generating an allocation of resources comprises:
referencing input data for the market participant corresponding to historical performance data for a combination of the market segment, the product, and the market channel;
comparing the historical performance data to a plurality of performance benchmarks;
estimating expected performances for a plurality of resource allocations based on the historical performance data and the plurality of performance benchmarks;
evaluating the expected performances of the plurality of allocations of resources; and
selecting an allocation of resources from the plurality of allocations of resources corresponding to the highest performance according to the metric,

3. The method according to claim 2, wherein applying a metric to evaluate the expected performances of the plurality of allocations of resources comprises comparing a proximity of the expected performances with achieving the business objective.

4. The method according to claim 3, wherein selecting an allocation of resources comprises selecting the allocation of resources from the plurality of allocations of resources corresponding to an expected performance which most closely approximates achieving the business objective.

6. The method according to claim 2, wherein the input data further comprises a plurality of channel partners, the plurality of channel partners corresponding to the plurality of market channels.

7. The method according to claim 6, wherein historical performance data comprises past market performance corresponding to the plurality of channel partners.

8. The method according to claim 7, wherein the estimating expected performances comprises estimating expected performances for the plurality of allocations of resources based on the historical performance data and the plurality of performance benchmarks for each channel partner of the plurality of channel partners.

9. The method according to claim 8, further comprising:
generating a ranked list of the channel partners comprised in the plurality of channel partners, wherein the ranked list is organized according to the expected performances of allocations corresponding to the channel partners.

10. The method according to claim 2 wherein the estimating performances for the plurality of allocations of resources comprises:
determining customer preference among the plurality of market channels; and
estimating expected performances for the plurality of allocations of resources based on customer preference, the historical performance data, and the plurality of performance benchmarks.

11. The method according to claim 1, wherein the business objective comprises a volume of sales for a duration of time.

12. The method according to claim 1, wherein the business objective comprises a percentage of market share.

13. The method according to claim 1, wherein the business objective comprises an amount of profits for a duration of time.

14. The method according to claim 1 wherein at least one of the plurality of performance benchmarks comprises an internal benchmark corresponding to the market participant.

15. The method according to claim 14, wherein the internal benchmark comprises a best performance achieved by the market participant according to the past market performance of the market participant.

16. The method according to claim 14, wherein the internal benchmark comprises an average performance achieved by the market participant according to the past market performance of the market participant.

17. The method according to claim 14, wherein the market participant comprises a participant in a plurality of markets; and
wherein the internal benchmark comprises the past market performance of the market participant in the plurality of markets.

18. The method according to claim 1 wherein at least one of the plurality of performance benchmarks comprises an industry benchmark.

19. A system for determining an high performing allocation of resources among a plurality of market channels, the system comprising:
a computer system having a processor coupled to a memory, the memory having tangible computer readable code containing program instructions, the program instructions comprising:
instructions to receive selections of: a market segment from a plurality of market segments, a product from a plurality of products corresponding to the market segment, and a market channel from a plurality of market channels corresponding to the market segment;
instructions to receive a business objective corresponding to a market participant; and
instructions to automatically generate an allocation of resources to best achieve the business objective for the market participant corresponding to a combination of the market segment, the product and the market channel.

20. The system according to claim 19, wherein the program instructions further comprise:
instructions to reference input data for the market participant corresponding to historical performance data for a combination of the market segment, the product, and the market channel;
instructions to compare the historical performance data to a plurality of performance benchmarks;
instructions to estimate expected performances for a plurality of resource allocations based on the historical performance data and the plurality of performance benchmarks;
instructions to evaluate the expected performances of the plurality of allocations of resources; and
instructions to select an allocation of resources from the plurality of allocations of resources corresponding to the highest performance according to the metric,

21. The system according to claim 19, wherein the program instructions further comprise instructions for implementing a graphical user interface configured to generate a graphical presentation of the expected performances.

22. The system according to claim 20, further comprising a display device coupled to the computer system, wherein the graphical user interface is displayed in the display device.

23. The system according to claim 20, wherein the instructions to evaluate the expected performances of the plurality of allocations of resources comprises instructions to compare a proximity of the expected performances with the business objective.

24. The system according to claim 23, wherein the instructions to select an allocation of resources comprises instructions to select the allocation of resources from the plurality of allocations of resources corresponding to an expected performance which most closely approximates the business objective.

25. The system according to claim 20 wherein the instructions to estimate performances for the plurality of allocations of resources comprises:
instructions to determine customer preference among the plurality of market channels; and
instructions to estimate expected performances for the plurality of allocations of resources based on customer preference, the historical performance data, and the plurality of performance benchmarks.

26. The system according to claim 20, wherein the input data further comprises a plurality of channel partners, the plurality of channel partners corresponding to the plurality of market channels.

27. The system according to claim 26, wherein historical performance data comprises past market performance corresponding to the plurality of channel partners.

28. The system according to claim 27, wherein the instructions to generate a plurality of allocations of resources comprises instructions to generate a plurality of allocations of resources from the available resources among the plurality of channel partners and between the plurality of market channels,
further wherein the instructions to estimate expected performances comprises instructions to estimate expected performances for the plurality of allocations of resources based on the historical performance data and the plurality of performance benchmarks, and among the plurality of channel partners.

29. The system according to claim 28, further comprising:
instructions to generate a ranked list of channel partners comprised in the plurality of channel partners, wherein the ranked list is organized according to the expected performances of allocations corresponding to the channel partners.

30. The system according to claim 20, wherein the instructions to estimate performances for the plurality of allocations of resources comprises:
instructions to determine customer preference among the plurality of market channels; and
instructions to estimate expected performances for the plurality of allocations of resources based on customer preference, the historical performance data, and the plurality of performance benchmarks.

31. A method for determining an high performing allocation of resources among a plurality of market channels, the method comprising:
receiving input data from a market participant, the input data comprising:
historical performance data corresponding to past market performance of the market participant in a plurality of market channels;
available resources of the market participant;
a plurality of performance benchmarks;
comparing the historical performance data to the plurality of performance benchmarks;
generating a plurality of allocations of resources from the available resources among the plurality of market channels;
estimating expected performances for the plurality of allocations of resources based the historical performance data and the plurality of performance benchmarks;
applying a metric to evaluate the expected performances of the plurality of allocations of resources; and
selecting an allocation of resources from the plurality of allocations of resources corresponding to the highest performance according to the metric,
wherein the receiving determining, the comparing, the generating, the estimating, the applying and the selecting are performed automatically during a process executed by a computing device.

32. The method according to claim 1, wherein the input data further comprises a pre-determined goal corresponding to a future market performance of the user.

33. The method according to claim 2, wherein applying a metric to evaluate the expected performances of the plurality of allocations of resources comprises comparing a proximity of the expected performances with the pre-determined goal.

34. The method according to claim 3, wherein selecting an allocation of resources comprises selecting the allocation of resources from the plurality of allocations of resources corresponding to an expected performance which most closely approximates the pre-determined goal.

35. A system for determining an allocation of resources among a plurality of market channels, the system comprising:
a computer system having a processor coupled to a memory, the memory having tangible computer readable code containing program instructions, the program instructions comprising:
instructions to receive input data comprising historical performance data corresponding to past market performance of a market participant in a plurality of market channels, available resources of the market participant, and a plurality of performance benchmarks;
instructions to compare the historical performance data to the plurality of performance benchmarks;
instructions to automatically generate a plurality of allocations of resources from the available resources among the plurality of market channels;
instructions to estimate expected performances for the plurality of allocations of resources based the historical performance data and the plurality of performance benchmarks;
instructions to apply a metric to evaluate the expected performances of the plurality of allocations of resources; and
instructions to select an allocation of resources from the plurality of allocations of resources corresponding to the highest performance according to the metric.

36. The system according to claim 35, wherein the program instructions further comprise instructions for implementing a graphical user interface configured to generate a graphical presentation of the expected performances.

37. The system according to claim 35, further comprising a display device coupled to the computer system, wherein the graphical user interface is displayed in the display device.

38. The system according to claim 35, wherein the instructions to evaluate the expected performances of the plurality of allocations of resources comprises instructions to compare a proximity of the expected performances with the pre-determined goal.

39. The system according to claim 38, wherein the instructions to select an allocation of resources comprises instructions to select the allocation of resources from the plurality of allocations of resources corresponding to an expected performance which most closely approximates the pre-determined goal.

40. The system according to claim 35 wherein the instructions to estimate expected performances for the plurality of allocations of resources comprises:
instructions to determine customer preference among the plurality of market channels; and
instructions to estimate expected performances for the plurality of allocations of resources based on customer preference, the historical performance data, and the plurality of performance benchmarks.

41. The system according to claim 35, wherein the input data further comprises a plurality of channel partners, the plurality of channel partners corresponding to the plurality of market channels.

42. The system according to claim 35, wherein historical performance data comprises past market performance corresponding to the plurality of channel partners.

43. The system according to claim 42, wherein the instructions to generate a plurality of allocations of resources comprises instructions to generate a plurality of allocations of resources from the available resources among the plurality of channel partners and between the plurality of market channels,
further wherein the instructions to estimate expected performances comprises instructions to estimate expected performances for the plurality of allocations of resources based on the historical performance data and the plurality of performance benchmarks, and among the plurality of channel partners.

44. The system according to claim 43, further comprising:
instructions to generate a ranked list of channel partners comprised in the plurality of channel partners, wherein the ranked list is organized according to the expected performances of allocations corresponding to the channel partners.

45. The system according to claim 35, wherein the instructions to estimate performances for the plurality of allocations of resources comprises:
instructions to determine customer preference among the plurality of market channels; and
instructions to estimate expected performances for the plurality of allocations of resources based on customer preference, the historical performance data, and the plurality of performance benchmarks.
